(19) United States
(12) Patent Application Publication
(10) Pub. No.: US 2022/0147919 A1
(43) Pub. Date: May 12, 2022

(54) DELIVERY MANAGEMENT DEVICE, DELIVERY SYSTEM, AND DELIVERY MANAGEMENT METHOD

(71) Applicant: TOYOTA JIDOSHA KABUSHIKI KAISHA, Toyota-shi Aichi-ken (JP)

(72) Inventors: Tetsuya Kanata, Toyota-shi Aichi-ken (JP); Masao Tajima, Toyota-shi Aichi-ken (JP); Takashi Hayashi, Toyota-shi Aichi-ken (JP); Nobuyuki Tomatsu, Nagoya-shi Aichi-ken (JP); Hideki Fukudome, Nisshin-shi Aichi-ken (JP); Takashi Hayashi, Nagoya-shi Aichi-ken (JP); Yoshiumi Kawamura, Nisshin-shi Aichi-ken (JP); Kosuke Akatsuka, Mishima-shi Shizuoka-ken (JP); Manabu Yamamoto, Toyota-shi Aichi-ken (JP); Kosuke Sakakibara, Toyota-shi Aichi-ken (JP)

(21) Appl. No.: 17/520,049

(22) Filed: Nov. 5, 2021

(30) Foreign Application Priority Data
Nov. 9, 2020 (JP) 2020-186799

(51) Int. Cl. G06Q 10/08; G06Q 30/02; G06Q 50/30

(52) U.S. Cl. CPC G06Q 10/0832; G06Q 50/30; G06Q 30/0207; G06Q 10/0833

(57) ABSTRACT

A delivery management device includes: a package information acquisition section configured to acquire information relating to a package for delivery; a delivery arrival date/time setting section configured to set a delivery arrival date and time for the package for delivery; a notification section configured to notify a reception destination of the delivery arrival date and time set by the delivery arrival date/time setting section; and a collection preference reception section configured to receive, from the reception destination, a preference for collection from a delivery vehicle or a periphery of a delivery vehicle.

### CROSS-REFERENCE TO RELATED APPLICATION

This application is based on and claims priority under 35 USC 119 from Japanese Patent Application No. 2020-186799 filed on Nov. 9, 2020, the disclosure of which is incorporated by reference herein.

### BACKGROUND

### Technical Field

The present disclosure relates to a delivery management device, a delivery system, and a delivery management method.

### Related Art

Japanese Patent Application Laid-Open (JP-A) No. 2009-217356 discloses a home delivery arrival time short notice system. When deliveries in a given delivery area have been completed, the home delivery arrival time short notice system predicts a delivery arrival time in the next delivery area, and notifies a delivery recipient of the predicted delivery arrival time by email.

The system disclosed in JP-A No. 2009-217356 enables the recipient to prepare to receive a package by giving the recipient advance notice of the predicted delivery arrival time. However, the effort on the part of a driver of a delivery vehicle in unloading the package from the delivery vehicle and delivering at a reception destination is not alleviated, leaving room for improvement in this regard.

### SUMMARY

The present disclosure provides a delivery management device, a delivery system, and a delivery management method capable of alleviating a burden on a delivery vehicle driver when delivering.

A first aspect of the present disclosure is a delivery management device including: a package information acquisition section configured to acquire information relating to a package for delivery; a delivery arrival date/time setting section configured to set a delivery arrival date and time for the package for delivery; a notification section configured to notify a reception destination of the delivery arrival date and time set by the delivery arrival date/time setting section; and a collection preference reception section configured to receive, from the reception destination, a preference for collection from a delivery vehicle or a periphery of a delivery vehicle.

In the delivery management device of the first aspect, information relating to the package for delivery is acquired by the package information acquisition section, and the delivery arrival date and time for the package for delivery is set by the delivery arrival date/time setting section. The reception destination is notified of the delivery arrival date and time by the notification section. This enables the recipient of the package for delivery to ascertain the delivery arrival date and time ahead of time.

The delivery management device also includes the collection preference reception section that receives from the reception destination the preference for collection from the delivery vehicle or the periphery of the delivery vehicle. The recipient can thereby express their preference for collection from the delivery vehicle or the periphery of the delivery vehicle, thus saving the driver of the delivery vehicle the effort of carrying the package to the reception destination. Moreover, the recipient is able to collect the package without having to wait for the driver to carry the package to them. Note that the “periphery of the delivery vehicle” is a concept that includes for example cases in which the package is picked up within a range of several tens of meters from the delivery vehicle, this being a range that does not feel burdensome to the driver.

A second aspect of the present disclosure, in the first aspect, may further include: a reward giving section configured to give a reward to the reception destination, wherein: the reward giving section gives a reward to the reception destination in cases in which pick-up has been completed at the delivery vehicle or in the periphery of the delivery vehicle in a state in which a preference for collection from the delivery vehicle or the periphery of the delivery vehicle has been received by the collection preference reception section from the reception destination.

In the delivery management device of the second aspect, the reward is given to the reception destination by the reward giving section in cases in which pick-up has been completed at the delivery vehicle or in the periphery of the delivery vehicle in a state in which the preference for collection from the delivery vehicle or the periphery of the delivery vehicle has been received by the collection preference reception section from the reception destination. This encourages the recipient to express a preference for collection, thus enabling the burden on the driver to be further alleviated.

A third aspect of the present disclosure, in the second aspect, may further includes: a reward calculation section configured to calculate a reward amount to be given by the reward giving section, wherein: the reward calculation section increases the reward in conjunction with an increase in size of the package for delivery and, further, increases the reward in conjunction with an increase in weight of the package for delivery.

In the delivery management device of the third aspect, increasing the reward for larger and heavier packages for delivery promotes collection of such packages that are more burdensome to the driver from the delivery vehicle or the periphery of the delivery vehicle.

In a fourth aspect of the present disclosure, in the first aspect, a location at which the delivery vehicle may be able to park close to a delivery destination is selected as a pick-up location by referencing position information regarding the delivery destination of the package for delivery on map data.

A fifth aspect of the present disclosure is a delivery system including: a delivery vehicle configured to deliver a package for delivery; and the delivery management device of any one of claim 1 to claim 4, wherein: a package access door configured to be opened and closed from a vehicle exterior is provided at a cargo bay of the delivery vehicle; and the package access door is configured to be unlocked by operation of a mobile terminal of a recipient.

In the delivery system of the fifth aspect, the package access door is provided to the cargo bay of the delivery vehicle, and the package access door is capable of being opened and closed from the vehicle exterior. The package access door is unlocked the recipient operating their mobile terminal, thereby enabling pick-up of the package for delivery to be performed without the driver having to disembark the vehicle.

A sixth aspect of the present disclosure is a delivery management method including: acquiring information relating to a package for delivery; setting a delivery arrival date and time for the package for delivery; notifying a reception destination of the delivery arrival date and time; and giving a reward to the reception destination in cases in which pick-up has been completed at the delivery vehicle or in a periphery of the delivery vehicle in a state in which a preference for collection from the delivery vehicle or the periphery of the delivery vehicle has been received from the reception destination

In the delivery management method of the sixth aspect, the reception destination is notified of the delivery arrival date and time, thereby enabling the recipient of the package for delivery to ascertain the delivery arrival date and time ahead of time. Moreover, giving the reward to the reception destination in cases in which pick-up has been completed at the delivery vehicle or in the periphery of the delivery vehicle encourages the recipient to express a preference for collection, thus enabling the burden on the driver to be further alleviated.

The delivery management device, the delivery system, and the delivery management method according to the present disclosure are capable of alleviating the burden on the delivery vehicle driver when delivering.

### BRIEF DESCRIPTION OF THE DRAWINGS

Exemplary embodiment of the present disclosure will be described in detail based on the following figures, wherein:

FIG. 1 is a schematic diagram illustrating an overall configuration of a delivery system including a delivery management device according to an exemplary embodiment;

FIG. 2 is a block diagram illustrating a hardware configuration of a delivery management device according to an exemplary embodiment;

FIG. 3 is a block diagram illustrating a functional configuration of a delivery management device according to an exemplary embodiment;

FIG. 4 is a sequence diagram illustrating an example of a flow of delivery management processing according to an exemplary embodiment;

FIG. 5 is a flowchart illustrating an example of a flow of delivery management processing according to an exemplary embodiment; and

FIG. 6 is a schematic diagram illustrating a delivery vehicle configuring a delivery system according to a modified example.

### DETAILED DESCRIPTION

Explanation follows regarding a delivery system 10 including a delivery management device 12 according to an exemplary embodiment, with reference to the drawings.

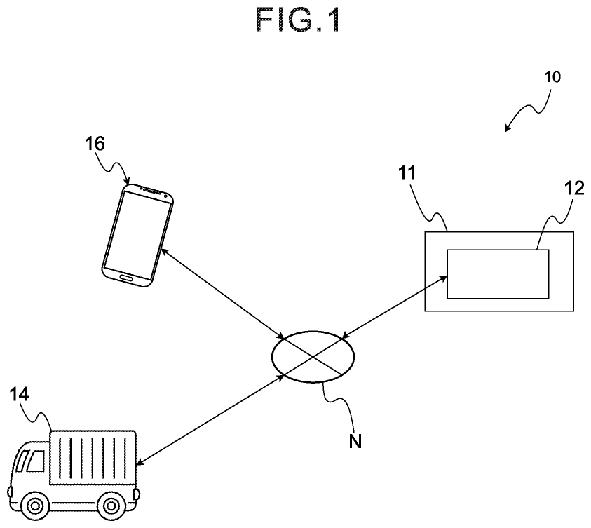

As illustrated in FIG. 1, the delivery system 10 of the present exemplary embodiment includes the delivery management device 12. The delivery management device 12 is provided at a delivery center 11, and is connected to a delivery vehicle 14 and a mobile terminal 16 over a network N. The mobile terminal 16 is a terminal such as a smartphone in the possession of a recipient of a package for delivery.

Hardware Configuration of Delivery Management Device 12

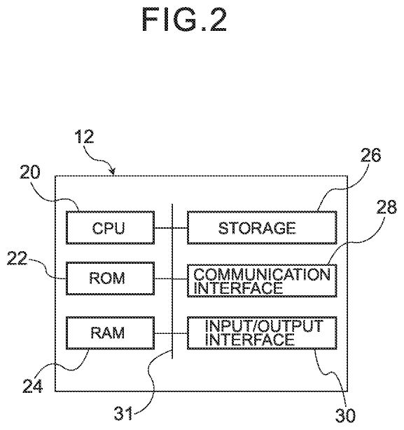

As illustrated in FIG. 2, the delivery management device 12 of the present exemplary embodiment is configured including a central processing unit (CPU) 20 (serving as a processor), read only memory (ROM) 22, random access memory (RAM) 24, storage 26, a communication interface 28, and an input/output interface 30. These configuration elements are connected together so as to be capable of communicating with each other through a bus 31.

The CPU 20 is a central processing unit that executes various programs and controls various sections. Namely, the CPU 20 reads a program from the ROM 22 or the storage 26, and executes the program using the RAM 24 as a workspace. The CPU 20 controls the various configurations and performs various arithmetic processing according to the program recorded in the ROM 22 or the storage 26.

The ROM 22 holds various programs and various data. The RAM 24 serves as a workspace that temporarily stores programs and data. The storage 26 is configured by a hard disk drive (HDD) or a solid state drive (SSD), and is configured by a non-transitory recording medium that holds various programs including an operating system, as well as various data. In the present exemplary embodiment, a program and the like used to execute delivery management processing are held in the ROM 22 or the storage 26.

The communication interface 28 is an interface employed by the delivery management device 12 to communicate over a computer network using a protocol such as 5G, LTE, Wi-Fi (registered trademark), Ethernet (registered trademark), or the like.

Various equipment is connected to the input/output interface 30. For example, a display and the like for displaying computation results may be connected to the input/output interface 30. A keyboard, a mouse, and the like for performing input to the delivery management device 12 may also be connected to the input/output interface 30.

Functional Configuration of Delivery Management Device 12

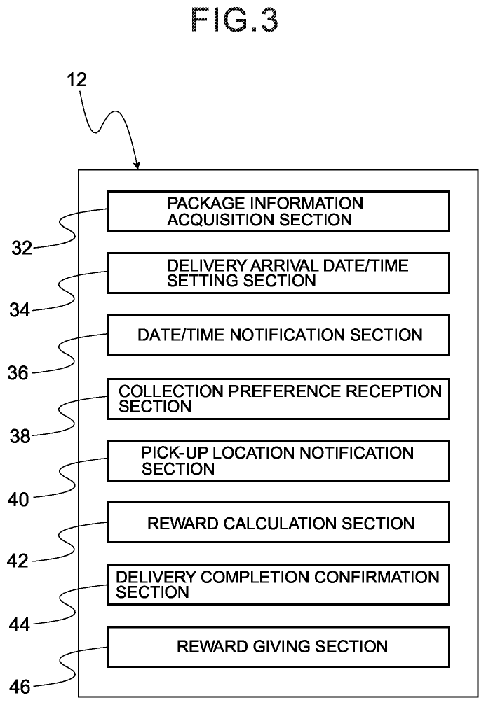

The delivery management device 12 implements various functionality employing the hardware resources described above. Explanation follows regarding functional configuration implemented by the delivery management device 12, with reference to FIG. 3.

As illustrated in FIG. 3, functional configuration of the delivery management device 12 includes a package information acquisition section 32, a delivery arrival date/time setting section 34, a date/time notification section 36, a collection preference reception section 38, a pick-up location notification section 40, a reward calculation section 42, a delivery completion confirmation section 44, and a reward giving section 46. Each of these functional configurations is implemented by the CPU 20 reading and executing the program stored in the ROM 22 or the storage 26.

The package information acquisition section 32 acquires information relating to packages for delivery (referred to hereafter simply as “packages”). As an example, in the present exemplary embodiment, the package information acquisition section 32 acquires information including a name and address of a package delivery destination, package sizes and package weights. For example, the package sizes are organized based on combined width direction, depth direction, and height direction dimensions of each package. The package sizes are classified into predetermined size classes according to the combined dimensions, and the appropriate size class is stored together with a package identification number in the storage 26 of the delivery management device 12 or on a server when undertaking delivery of a package. For example, in sequence from smallest to largest, packages may be classified into size classes of S size, M size, L size, and XL size.

The package weights are classified according to predetermined ranges, and a weight class is stored together with the package identification number in the storage 26 of the delivery management device 12 or on a server when undertaking delivery of a package. For example, packages may be classified into weight classes of under 2 kg, under 5 kg, under 10 kg, and under 15 kg.

The package information acquired by the package information acquisition section 32 is managed using radio frequency identifier (RFID) tags or the like. Package information can be acquired by reading the tag accompanying the package. Note that other methods may also be applied for package information management. For example, package information may be managed using barcodes or the like.

The delivery arrival date/time setting section 34 sets a date and time for package delivery arrival. Specifically, in cases in which a preferred delivery arrival date and time have been specified when undertaking delivery, the delivery arrival date/time setting section 34 sets the delivery arrival date and time such that the delivery can be handed over at the specified preferred delivery arrival date and time. In cases in which a preferred delivery arrival date and time has not been specified, the delivery arrival date/time setting section 34 may set the delivery arrival date and time so as to enable the package to be loaded into the delivery vehicle 14 at the same timing as packages destined for delivery in the same neighborhood.

The date/time notification section 36 notifies a reception destination of the delivery arrival date and time set by the delivery arrival date/time setting section 34. As an example, in the present exemplary embodiment, the delivery arrival date/time setting section 34 may notify the mobile terminal 16 in the possession of a recipient who is the reception destination of the delivery arrival date and time using email or the like.

The date/time notification section 36 is not limited to notifying the mobile terminal 16 on departure of the package, and may notify the mobile terminal 16 while the package is en-route. In such cases, the date/time notification section 36 may notify the mobile terminal 16 of the delivery arrival date and time at a stage after the delivery vehicle 14 has reached the delivery neighborhood and a precise delivery arrival time has been finalized.

The collection preference reception section 38 receives from the reception destination a preference for collection from the delivery vehicle 14 or the periphery of the delivery vehicle 14. As an example, in the present exemplary embodiment, when the date/time notification section 36 notifies the mobile terminal 16 of the delivery arrival date and time, the collection preference reception section 38 performs guidance to establish whether or not collection is preferred. For example, if the recipient selects a uniform resource locator (URL) corresponding to a preference for collection included in an email, a signal indicating a preference for collection is transmitted from the mobile terminal 16. Note that configuration may be made such that collection preference information is held with the package information when the recipient selects this URL. In this manner, the collection preference reception section 38 receives from the reception destination a preference for collection from the delivery vehicle 14 or the periphery of the delivery vehicle 14 by the recipient.

The pick-up location notification section 40 notifies the recipient of a pick-up location. Specifically, the pick-up location notification section 40 notifies the mobile terminal 16 of a position where the delivery vehicle 14 is able to park close to the reception destination address that will be the pick-up location. Although the pick-up location may be chosen by either the delivery management device 12 or the driver of the delivery vehicle 14, in the present exemplary embodiment as an example, the pick-up location is chosen by the delivery management device 12.

In cases in which the delivery management device 12 chooses the pick-up location, the delivery management device 12 references position information for the package delivery destination on map data, and selects a location where the delivery vehicle 14 is able to park close to the delivery destination. The pick-up location notification section 40 then transmits position information for the selected pick-up location to the mobile terminal 16 of the recipient. When this is performed, the pick-up location notification section 40 also notifies the delivery vehicle 14 or the driver of the delivery vehicle of the position information for the pick-up location.

Note that in cases in which the driver of the delivery vehicle 14 chooses the pick-up location, the driver may register a desired position as the pick-up location on a navigation system installed in the delivery vehicle 14. In such cases, the position information registered by the driver is transmitted to the delivery management device 12. The pick-up location notification section 40 then transmits the position information for the pick-up location received from the delivery vehicle 14 to the mobile terminal 16 of the recipient.

The reward calculation section 42 calculates a reward amount for the reward giving section 46, described later, to give the recipient. As an example, the reward calculation section 42 of the present exemplary embodiment calculates points that can be utilized under a point scheme (loyalty program). The points given to the recipient as a reward can be used in payment when purchasing goods, or used in lieu of payment for postage and packaging.

Moreover, in the present exemplary embodiment, the reward calculation section 42 is configured to increase the reward as the package size becomes longer. For example, in cases in which package sizes are classified into an S size, M size, L size, and XL size, rewards are calculated such that an M size package will reward a greater number of points than an S size package.

Furthermore, in the present exemplary embodiment, the reward calculation section 42 is also configured to increase the reward as the package weight becomes heavier. For example, rewards are calculated such that a package in a weight class of under 5 kg will give a greater number of points than a package in a weight class of under 2 kg. The reward calculation section 42 may also calculate points according to the package type. For example, the reward calculation section 42 may calculate the reward such that an irregularly-shaped package that is comparatively difficult to carry will give a greater number of points than a box-shaped package that is comparatively easy to carry.

The delivery completion confirmation section 44 confirms delivery completion. As an example, in the present exemplary embodiment, after pick-up of a package has been completed, the driver transmits a signal indicating delivery completion to the delivery management device 12 using a dedicated driver terminal or the like. The delivery management device 12 then updates the delivery completion status for the package information held in the storage 26. The delivery completion confirmation section 44 references the package information in order to confirm that the delivery completion status has been updated.

The reward giving section 46 gives the reward to the reception destination. Specifically, the reward giving section 46 gives points in cases in which pick-up has been completed at the delivery vehicle 14 or in the periphery of the delivery vehicle 14 in a state in which a preference for collection from the delivery vehicle 14 or the periphery of the delivery vehicle 14 has been received by the collection preference reception section 38 from the reception destination. The points to be given to the reception destination are calculated by the reward calculation section 42.

Various methods may be adopted as the method by which the reward giving section 46 gives points to the reception destination. For example, in cases in which a loyalty program user identification number of the recipient is registered in the storage 26, an external server, or the like, processing may be performed to give points to this user identification number. Alternatively, the mobile terminal 16 of the recipient may be notified by email or the like of a coupon code corresponding to the point allocation. In such cases, the recipient can access the points by visiting a website that manages the loyalty program and inputting the coupon code.

Operation

Next, explanation follows regarding operation of the present exemplary embodiment.

Example of Delivery Management Processing

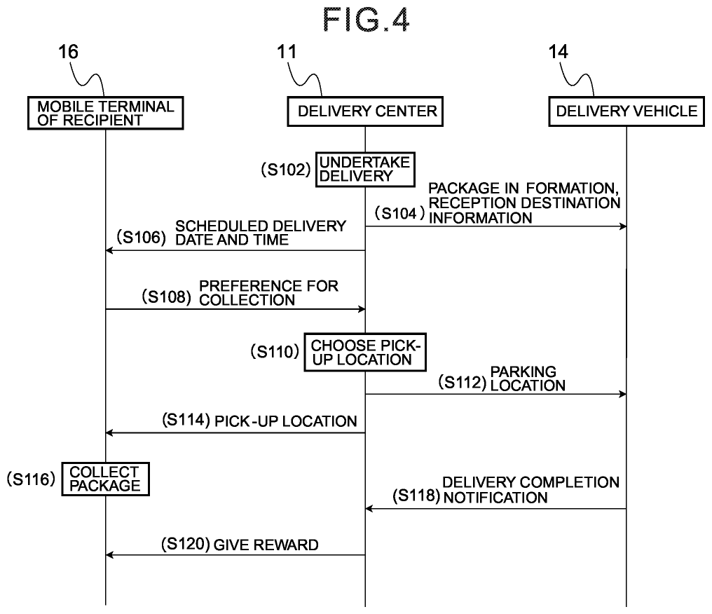

FIG. 4 is a sequence diagram illustrating an example of a flow of delivery management processing by the delivery management device 12. This delivery management processing is implemented by the CPU 20 functioning as the package information acquisition section 32, the delivery arrival date/time setting section 34, the date/time notification section 36, the collection preference reception section 38, the pick-up location notification section 40, the reward calculation section 42, the delivery completion confirmation section 44, and the reward giving section 46. Note that the delivery vehicle 14 described in the following explanation is not limited to a system installed in the delivery vehicle 14, and may encompass a terminal or the like in the possession of the driver of the delivery vehicle 14.

At step S102, the delivery center 11 undertakes delivery of a package. When this is performed, information regarding the package is acquired and registered in a database.

At step S104, the delivery center 11 transmits package information and reception destination information to the delivery vehicle 14. The package information is information such as the number of packages as well as the size and weight of each package. The reception destination information is information such as reception destination position information and a name.

At step S106, the delivery center 11 notifies the mobile terminal 16 of the recipient of a scheduled delivery date and time, for example by email. This notification includes guidance for expressing a preference for collection.

At step S108, a collection preference signal is transmitted from the mobile terminal 16 of the recipient to the delivery center 11. Note that this communication regarding a preference for collection may be transmitted directly to the delivery vehicle 14.

Having received the collection preference signal at step S108, at step S110, the delivery center 11 chooses the pick-up location on map data. The pick-up location is selected from out of locations that are close to the reception destination that are also locations where a parking space for the delivery vehicle 14 can also be secured.

At step S112, the delivery center 11 notifies the delivery vehicle 14 of a parking location. Then, at step S114, the delivery center 11 notifies the recipient of position information relating to the pick-up location.

At step S116, the recipient moves to the notified pick-up location, and collects the package from the delivery vehicle 14. When this is performed, the driver of the delivery vehicle 14 may unload the corresponding package and pass the package to the recipient, or the recipient may collect the package by unloading the package from a cargo bay of the delivery vehicle 14 themselves.

At step S118, a delivery completion notification signal is transmitted from the delivery vehicle 14 to the delivery center 11. After receiving the delivery completion notification at step S118, the delivery center 11 gives a reward to the recipient at step S120.

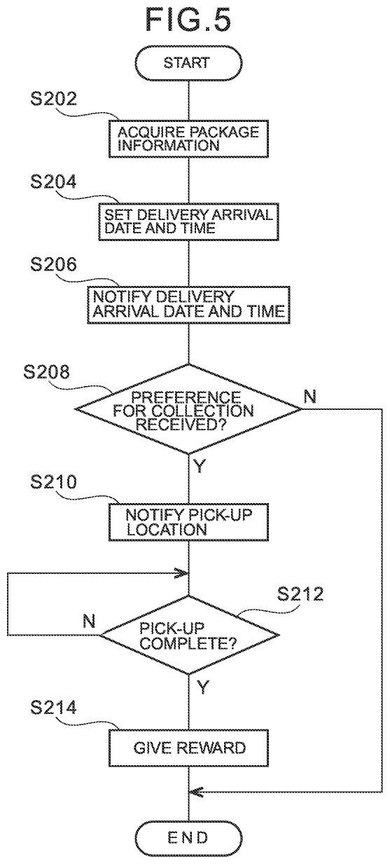

FIG. 5 is a flowchart illustrating an example of a flow of delivery management processing by the delivery management device 12. This delivery management processing is executed by the CPU 20 reading a program from the ROM 22 or the storage 26, and expanding and executing the program in the RAM 24.

At step S202, the CPU 20 utilizes the functionality of the package information acquisition section 32 in order to acquire package information. At step S204, the CPU 20 utilizes the functionality of the delivery arrival date/time setting section 34 to set a delivery arrival date and time. Specifically, in cases in which a preferred delivery arrival date and time have been specified when undertaking the delivery, the delivery arrival date and time are set so as to enable delivery at the specified preferred delivery arrival date and time. In cases in which a preferred delivery arrival date and time have not been specified, the delivery arrival date and time are set based on the delivery statuses of other packages.

At step S206, the CPU 20 utilizes the functionality of the date/time notification section 36 to notify the reception destination of the delivery arrival date and time.

At step S208, the CPU 20 determines whether or not a preference for collection has been received from the reception destination. In cases in which the CPU 20 has received a preference for collection from the delivery vehicle 14 or the periphery of the delivery vehicle 14 from the recipient using the functionality of the collection preference reception section 38, processing transitions to step S210. In cases in which the CPU 20 has not received communication of a preference for collection from the delivery vehicle 14 or the periphery of the delivery vehicle 14 from the recipient, the CPU 20 determines that no preference for collection has been received and the delivery management processing is ended. Note that delivery is performed in the normal manner in such cases.

At step S210, the CPU 20 utilizes the functionality of the pick-up location notification section 40 to notify the recipient of the pick-up location. At step S212, the CPU 20 then utilizes the functionality of the delivery completion confirmation section 44 to determine whether or not pick-up of the package has been completed. Note that in cases in which the package was picked up at the delivery vehicle 14 or the periphery of the delivery vehicle 14, the CPU 20 makes affirmative determination at step S212 and processing transitions to step S214.

At step S214, the CPU 20 utilizes the functionality of the reward giving section 46 to give a reward to the recipient.

Note that in the flowchart in FIG. 5, no consideration is given to cases in which the package was not picked up at the delivery vehicle 14 or in the periphery of the delivery vehicle 14 after receiving a preference for collection. However, alternative processing may be performed in such cases. For example, in cases in which the recipient does not come to collect the package after a preference for collection has been received, the package may be taken back to the delivery center 11. Alternatively, the driver may deliver the package in the normal manner, and not give a reward. Alternatively, in cases in which the recipient does not come to collect the package after a preference for collection has been received, the recipient may be charged a higher delivery fee than the standard delivery fee.

As described above, in the present exemplary embodiment, the reception destination is notified of the delivery arrival date and time using the functionality of the date/time notification section 36, thereby enabling the recipient of the package to ascertain the delivery arrival date and time ahead of time.

In the present exemplary embodiment, the recipient can express a preference for collection from the delivery vehicle 14 or the periphery of the delivery vehicle 14, thus saving the driver of the delivery vehicle 14 the effort of carrying the package to the reception destination. At the same time, the recipient is able to collect the package without having to wait for the driver to carry the package to them. This enables the burden on the driver of the delivery vehicle 14 when delivering to be alleviated.

Moreover, in the present exemplary embodiment, in cases in which pick-up is completed at the delivery vehicle 14 or in the periphery of the delivery vehicle 14, the reception destination is given a reward using the functionality of the reward giving section 46. So doing encourages the recipient to express a preference for collection, thus enabling the burden on the driver to be further alleviated.

In particular, in the present exemplary embodiment, increasing the reward in the case of large packages and heavy packages encourages the recipient to express a preference for collection of packages, such that the driver does not need to carry more burdensome packages to the reception destination.

Moreover, in the present exemplary embodiment, the delivery management device 12 is configured to choose the pick-up location of the package. There is accordingly no need for the driver to think about where to park, allowing the driver to concentrate on driving.

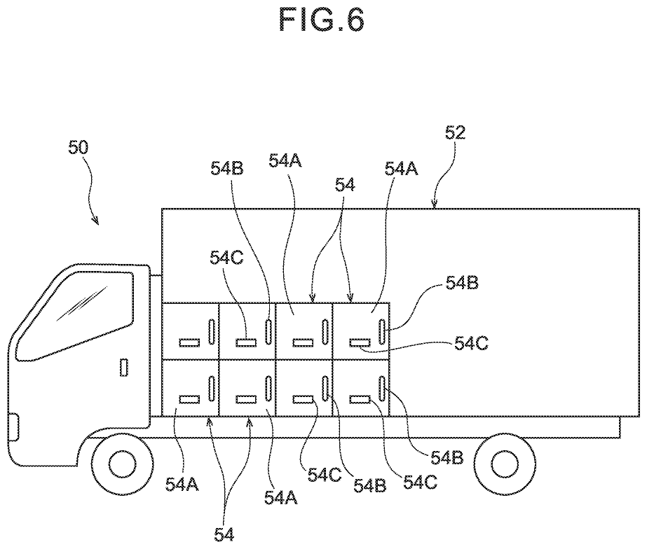

Note that although explanation has been given regarding a case in which packages are delivered by the delivery vehicle 14 furnished with a typical cargo bay in the exemplary embodiment described above, there is no limitation thereto. For example, a delivery vehicle 50 of a modified example, illustrated in FIG. 6, may be employed to perform package delivery.

### MODIFIED EXAMPLE

As illustrated in FIG. 6, plural cargo compartments 54 are provided in part of a cargo bay 52 of the delivery vehicle 50 according to this modified example. As an example, in the present modified example, eight of the cargo compartments 54 are provided.

Each of the cargo compartments 54 is formed in a substantially box shape so as to open toward a vehicle width direction outer side, and includes an internal space capable of housing a package. An opening of each cargo compartment 54 is closed off by a package access door 54A.

Each of the package access doors 54A is formed in a substantially rectangular shape as viewed from the vehicle width direction outer side, and a handle 54B and an authentication section 54C are provided to each of the package access doors 54A. The package access door 54A is locked by a non-illustrated lock mechanism, and after a package has been housed, the package access door 54A cannot be opened or closed until unlocked by the recipient.

The handle 54B is provided to a vehicle rear side end portion of the corresponding package access door 54A, and is configured in a shape that can be gripped by the recipient. As an example, in the present modified example, the handle 54B is formed in a substantially U shape, with both ends of the handle 54B abutting and fixed to the package access door 54A.

Note that a push button or the like may be provided instead of the handle 54B. Alternatively, the handle 54B may be omitted in cases in which the package access door 54A is configured to open automatically.

The authentication section 54C is configured including a reader used to authenticate the recipient. As an example, the authentication section of the present modified example is configured to read a two-dimensional code displayed on a screen of the mobile terminal 16 in the possession of the recipient.

The delivery vehicle 50 is configured as described above. Moreover, in the present modified example, in the sequence diagram in FIG. 4, a two-dimensional code is notified to the mobile terminal 16 from the delivery center 11 together with notification of the pick-up location at step S114. Moreover, at step S114, the delivery center 11 also notifies the mobile terminal 16 of the position of the cargo compartment 54 housing the package. Note that the two-dimensional code includes identification number data used to identify the package. A different two-dimensional code is generated by the delivery management device 12 for each package based on the package information.

The recipient then moves to the pick-up location, taking the mobile terminal 16 with them. The recipient then displays the two-dimensional code on the mobile terminal 16 and allows the authentication section 54C of the cargo compartment 54 housing the package to read the two-dimensional code. The delivery management device 12 then determines whether or not the identification number corresponding to the two-dimensional code read by the authentication section 54C matches a package identification number stored in the storage 26. If the package identification number matches, the locking of the corresponding package access door 54A is released so as to allow the recipient to remove their package from the cargo compartment 54.

Note that a sensor, such as an infra-red sensor that detects for the presence of a package, is provided inside the cargo compartment 54 to detect when the recipient has removed their package. When the recipient has removed their package, the delivery vehicle 50 sends a delivery completion notification to the delivery center 11, as illustrated by step S118 in FIG. 4. A reward is then given to the recipient at step S120.

In the modified example described above, there is no need for the driver of the delivery vehicle 50 to unload the package, enabling the burden on the driver to be greatly alleviated. Moreover, the driver does not need to perform the delivery completion notification. On the other hand, the recipient does not need to worry about potential accidents such as the driver dropping the package during delivery.

Note that in the modified example described above, explanation has been given regarding a configuration in which the authentication section 54C reads a two-dimensional code. However, there is no limitation thereto. For example, an authentication section may perform authentication by being input with a predetermined authentication code. Alternatively, an authentication method employing biometric authentication such as fingerprint authentication or iris authentication may be applied.

Moreover, in the modified example described above, the authentication sections 54C are provided to all of the package access doors 54A. However, there is no limitation thereto. For example, a single authentication section 54C may be provided at a separate location to the package access doors 54A. In such cases, once authentication has been performed using the authentication section 54C, the lock of the package access door 54A corresponding to the authenticated identification number may be released.

Moreover, configuration may be made such that a reward is given to the recipient at a timing corresponding to completion of authentication by the authentication section 54C.

Although explanation has been given regarding the delivery management device 12 according to the above exemplary embodiment and the modified example, obviously various implementations are possible within a range not departing from the spirit of the present disclosure. For example, although the reward calculation section 42 of the exemplary embodiment described above is configured so as to change the reward according to the size and weight of the package, the reward may be changed based on other information in addition to, or instead of, the size and weight of the package. Namely, the reward may be changed according to whether the reception destination is at a multiple-residency dwelling or a detached house. Specifically, the reward may be increased in the case of multiple-residency dwellings where a greater amount of time is required to move to the pick-up location than in the case of a detached house. Moreover, in the case of multiple-residency dwellings, the reward may be fine-tuned according to factors such as the presence or absence of an elevator or the level on which the recipient lives.

In the exemplary embodiment described above, the reward giving section 46 gives points to the recipient as a reward. However, there is no limitation thereto. For example, the reward giving section 46 may give an electronic money balance to the recipient instead of points. Alternatively, for example, the reward giving section 46 may give a coupon or the like that can be used as part payment for goods or services.

In the exemplary embodiment described above, although explanation has been given regarding configurations in which the delivery management device 12 is provided at the delivery center 11, there is no limitation thereto. For example, the delivery management device 12 may be provided in the delivery vehicle 14 or the delivery vehicle 50. In such cases, communication can be performed between the delivery vehicle 14, 50 and the mobile terminal 16 directly.

Note that the processing executed by the CPU 20 reading and executing software (a program) in the above exemplary embodiment may be executed by various types of processor other than the CPU 20. Examples of such processors include programmable logic devices (PLD) that allow circuit configuration to be modified post-manufacture, such as a field-programmable gate array (FPGA), and dedicated electric circuits configured by processors including a circuit configuration custom-designed to execute specific processing, such as an application specific integrated circuit (ASIC). The delivery management processing may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

Moreover, in the exemplary embodiment described above, although the storage 26 is employed as a recording section, there is no limitation thereto. For example, a non-transitory recording medium such as a compact disc (CD), digital versatile disc (DVD), or universal serial bus (USB) memory may be employed as a recording section. In such cases, the various programs may be held in such recording media.

What is claimed is:

1. A delivery management device, including a processor, wherein the processor is configured to:
acquire information relating to a package for delivery;
set a delivery arrival date and time for the package for delivery;
notify a reception destination of the delivery arrival date and time; and
receive, from the reception destination, a preference for collection from a delivery vehicle or a periphery of a delivery vehicle.

2. The delivery management device of claim 1, wherein the processor is further configured to:
give a reward to the reception destination in cases in which pick-up has been completed at the delivery vehicle or in the periphery of the delivery vehicle in a state in which a preference for collection from the delivery vehicle or the periphery of the delivery vehicle has been received from the reception destination.

3. The delivery management device of claim 2, wherein the processor is further configured to increase the reward in conjunction with an increase in size of the package for delivery and, further, to increase the reward in conjunction with an increase in weight of the package for delivery.

4. The delivery management device of claim 1, wherein the processor is further configured to select a location at which the delivery vehicle is able to park close to a delivery destination as a pick-up location by referencing position information regarding the delivery destination of the package for delivery on map data.

5. A delivery system, comprising:
a delivery vehicle configured to deliver a package for delivery; and
the delivery management device of claim 1, wherein:
a package access door configured to be opened and closed from a vehicle exterior is provided at a cargo bay of the delivery vehicle; and
the package access door is configured to be unlocked by operation of a mobile terminal of a recipient.

6. A delivery management method for a processor, the method comprising:
acquiring information relating to a package for delivery;
setting a delivery arrival date and time for the package for delivery;
notifying a reception destination of the delivery arrival date and time; and
giving a reward to the reception destination in cases in which pick-up has been completed at the delivery vehicle or in a periphery of the delivery vehicle in a state in which a preference for collection from the delivery vehicle or the periphery of the delivery vehicle has been received from the reception destination.
